(19) United States
(12) Patent Application Publication
(10) Pub. No.: US 2022/0018048 A1
(43) Pub. Date: Jan. 20, 2022

(54) METHOD AND DEVICE FOR PRODUCING TUBULAR CELLULOSIC SPUN-BONDED NONWOVEN FABRICS

(71) Applicant: LENZING AKTIENGESELLSCHAFT, 4860 Lenzing (AT)

(72) Inventor: Ibrahim Sagerer-Foric, 4840 Vocklabruck (AT)

(21) Appl. No.: 17/299,606

(22) PCT Filed: Dec. 4, 2019
(86) PCT No.: PCT/EP2019/083692

§ 371 Date: Jun. 3, 2021

(30) Foreign Application Priority Data
Dec. 5, 2018 (EP) 18210508.0

(51) Int. Cl. D04H 3/073; B01D 39/18; D04H 3/03; D06M 13/535

(52) U.S. Cl. CPC D04H 3/073; B01D 39/18; D06M 2101/06; D06M 13/535; D04H 3/03

(57) ABSTRACT

A device for producing a seamless tubular cellulosic spunbonded nonwoven fabric, comprising a spinning dope production (8), a spinning system (2), a coagulation system (4), a deposition section (3) for depositing and dewatering the spunbonded nonwoven, a transport device (13, 22) for carrying off the spunbonded nonwoven in the transport direction, a washing system (5) and a drying system (6), wherein the deposition section (3) is designed so as to be rotatable, with the axis of rotation of the deposition section (3) lying along the transport direction.

The present invention relates to a device for producing a tubular cellulosic spunbonded nonwoven fabric, comprising a spinning dope production, a spinning system, a coagulation system, a deposition section for depositing and dewatering the spunbonded nonwoven, a transport device for carrying off the spunbonded nonwoven in the transport direction, a washing system and a drying system. Furthermore, the invention relates to a method of producing a tubular cellulosic spunbonded nonwoven fabric and various uses of such a spunbonded nonwoven fabric.

### BACKGROUND OF THE INVENTION

Cellulose is used as a filter medium in various filter systems because it has specific properties and, in addition, can be used at temperatures above 80° C. According to the prior art, there are pressed cellulose filter cartridges or nonwovens fabrics which are bonded with adhesives and are coated with cellulose or, respectively, cellulose fibres and in which, for example, phenolic resins are used for binding the cellulose on the typically thermoplastic nonwoven filter web. Consequently, the production of the filter material is already very complicated in comparison to seamless filtering tubes and filter cartridges. The filter cartridges described in U.S. Pat. No. 7,081,201 and US 2010/0089819 are composed of several parts and their manufacture is thus more complex than that of seamless filter cartridges. The use of cellulose as a filter material in liquids and gases has so far required elaborate compacting or coating processes, the use of adhesives and complex support structures and apparatuses. The resins and adhesives used for the adhesion can limit the application areas of the filter if they are not compatible with the medium to be filtered or, respectively, undesirable chemical reactions may occur between the filter material and the medium to be filtered. Also, in compacted cellulose filter cartridges, short cellulose fibres may become loose, leading to undesirable effects in the further process. Therefore, it has not been possible so far to produce seamless filtering tubes and filter cartridges directly from cellulose without binders.

For example, cellulosic fibres can be produced according to the lyocell process (as described, e.g., in U.S. Pat. Nos. 4,246,221, 6,306,334, and 5,779,737) and can then be processed into nonwoven fabrics via multiple process steps. Since the fibre diameters of staple fibres usually exceed 10 μm, the nonwoven fabrics produced therefrom are very porous and can be used for filtration applications only in restricted areas.

The methods for the production of spunbonded nonwovens from lyocell spinning dope, as described in U.S. Pat. Nos. 6,358,461, 8,029,259, 8,366,988, 6,306,334, are concerned with the production and aftertreatment of two-dimensional planar assemblies or nonwoven fabrics, respectively. Although those nonwoven fabrics have the necessary fineness and porosity which allow them to be used as filter materials for liquid and gas filtration, the nonwoven fabrics still have to be subjected to a costly aftertreatment, possibly connected to carrier webs, folded and incorporated into filtering cartridges. The previously known devices for the production of lyocell spunbonded nonwovens cannot be used for the production of filtering tubes or filter cartridges, since the equipment has been developed only for sheet products and their properties.

Tubular seamless spunbonded nonwoven fabrics can be produced only from thermoplastic melts by means of meltblown processes by—as illustrated in U.S. Pat. No. 3,905,736—extruding polymer melts through a meltblown nozzle, drawing them with hot air and depositing them on a rotating surface. Since the thermoplastic filaments are still hot, adhesive points emerge during the deposition between the individual layers at the points of contact between filaments. Due to the rotation of the deposition surface and the described adhesive effect, a seamless spunbonded nonwoven tube is formed from a plurality of interconnected nonwoven fabric layers, which tube can be drawn off continuously and, subsequently, can be processed into a nonwoven web. Processing into filter cartridges is described in U.S. Pat. Nos. 3,801,400 and 3,933,557, and processing into filtering tubes is described in U.S. Pat. Nos. 3,905,734 and 4,032,688.

The spunbonded nonwoven tubes can be produced by one or several nozzles in various arrangements, as described in U.S. Pat. No. 8,231,752. According to U.S. Pat. No. 5,409,642, the filament diameter can be varied between the individual layers in order to improve the filtration effect. The production of spunbonded nonwoven tubes can be conducted batchwise or—as described in U.S. Pat. No. 3,933,557—continuously. The previous methods have largely been used for the production of spunbonded nonwoven tubes from thermoplastic materials, and the devices have been optimized for those raw materials. Based on the above-mentioned variation possibilities, it is possible, for example, to produce filter cartridges with high separation efficiency and high filter capacity. Since, until now, mainly thermoplastics can be used for the described methods, the application areas are restricted at higher temperatures (>80° C.).

Since the production of thermoplastic tubular spunbonded nonwoven fabrics is a dry spinning process in which the adhesions can be adjusted only by changing the temperature of the extruded filaments, the hitherto known devices and methods only serve for the shaping of the filtering tube. In contrast, cellulosic spinning dopes are cellulose solutions in which the temperature effect cannot be utilized to the same extent as with thermoplastics, but other ways of generating the adhesions must be found. In addition, coagulation liquids are sprayed onto the extruded filaments during the production of cellulosic spunbonded nonwovens, wherein, subsequently, both the coagulant and the solvent must be removed and recovered from the spunbonded nonwoven tube and from the exhaust air for economic, environmental and safety reasons. In contrast to known devices for thermoplastics, the cellulosic spunbonded nonwoven tube also has to be dewatered, washed and dried immediately after the deposition in order to minimize the amount of solvent in the product and to stabilize the shape of the tube that has been produced.

### BRIEF DESCRIPTION OF THE INVENTION

So far, it has not been possible to produce seamless filtering tubes and filter cartridges directly from cellulosic spinning dope and without binders. Since the hitherto known devices and methods fail to meet the above-mentioned requirements, it is an object of the present invention to provide a device and a method for producing cellulosic spunbonded nonwoven tubes. In particular, the direct production of seamless, multi-layered, binder-free, tubular cellulosic spunbonded nonwoven fabrics, for example, for a filter, shall be rendered possible.

Said object is achieved by a device for producing a tubular cellulosic spunbonded nonwoven fabric, comprising

a spinning dope production,

a spinning system,

a coagulation system,

a deposition section for depositing and dewatering the spunbonded nonwoven,

a transport device for carrying off the spunbonded nonwoven in the transport direction,

a washing system and

a drying system,

characterized in that the deposition section is designed so as to be rotatable, with the axis of rotation of the deposition section lying along the transport direction.

Furthermore, it may be provided that a suction device is associated to the deposition section.

The suction device may be inclined at least in sections in order to take into account the increase in thickness of the tube due to deposited filaments.

The suction device can be used both for the suctioning and, respectively, dewatering of the spunbonded nonwoven, and for the extraction and removal of process air.

In a further embodiment, a plurality of suction devices can be arranged—for example, directly—below the rotatable deposition section, or at a distance of 1to 100 cm, preferably 10 to 50 cm, more preferably 20 to 40 cm, in order to extract the solvent-laden process air stream, subsequently feeding it to the solvent recovery.

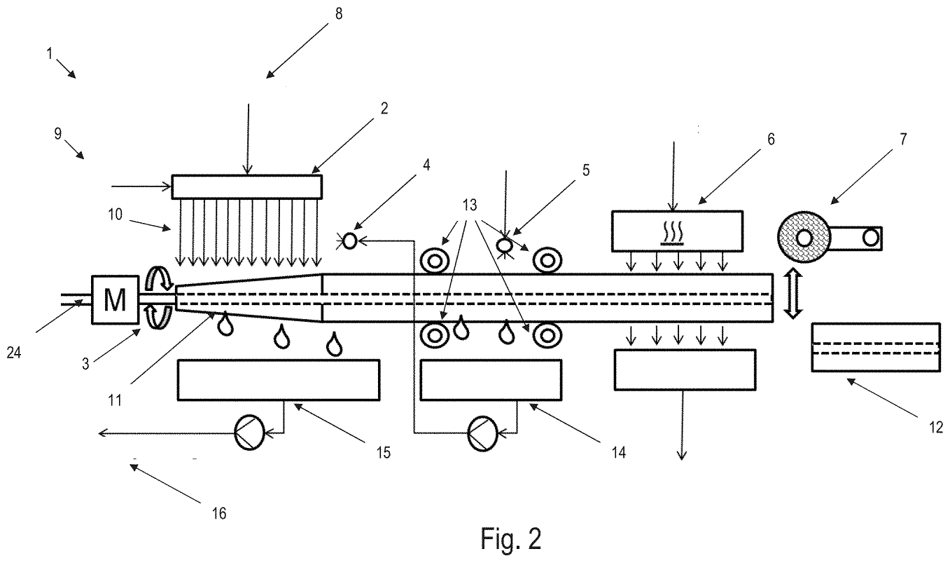

In addition, the device can be enclosed (see FIG. 2 below) so that the solvent-laden exhaust air can be removed within the enclosure by a large-scale suction device, and a contamination of the surrounding plant space is prevented.

Furthermore, a cutting unit may be provided.

Preferably, the cutting unit is arranged downstream of the drying system.

Furthermore, the object is achieved by a method of producing a preferably seamless, multi-layered tube made of cellulose, wherein cellulose is processed into a spinning dope and, subsequently, is extruded with a spinning system to form filaments and is drawn by means of hot air, wherein the drawn filaments are moistened, before the deposition, with a coagulation liquid in such a way that adhesions will form in places between the drawn filaments, whereupon the drawn filaments, which adhere to each other section wise, are deposited on a rotating tray and wherein further adhesions with the filaments already located on the rotating tray are formed by means of coagulation liquid.

It has been shown that the degree of adhesion can be specifically influenced by the coagulation (amount of coagulation liquid, temperature, concentration, surface of the liquid mist), i.e., the regeneration of the cellulose. In this connection, the fusion of several individual filaments at their points of contact is referred to as an adhesion. Before they impinge on the tray, the filaments are moistened with the coagulation liquid only to the extent that they remain partly liquid and fuse together upon contact, whereby an adhesion is created. Surprisingly, the adhesive effect could be adjusted such that the adhesions could be produced not only in flight, i.e., in a spunbonded nonwoven layer, but also on impact, between filaments that had already been deposited and filaments in the process of impinging, and, thus, a wet but dimensionally stable tube which adhere to each other across several layers was created. According to the invention, no coagulation liquid is applied in extreme cases, and a maximum of adhesions is thereby produced. In this case, the adhesions can be spherical, for example, or else flat and can have a diameter of 10 nm to 500 nm, preferably 30 μm to 300 μm, more preferably 50 to 200 μm. The coagulation liquid can either be injected directly into the process air or sprayed onto the filament curtain via a wide variety of spraying and nebulization systems. Water and various solvent mixtures such as, e.g., an NMMO/water mixture (N-methylmorpholine-N-oxide) can be used as the coagulation liquid. The concentration of NMMO in the coagulation liquid may be between 0-45%, preferably from 10 to 40%, more preferably between 20 and 30%. The temperature of the coagulation liquid may be between 5° C. and 90° C., preferably between 10° C. and 70° C., more preferably between 20° C. and 60° C.

One aspect of the invention relates to a seamless cellulosic tube consisting of several layers of drawn filaments that that adhere to each other. Both the number and the size of the adhesive points can be almost constant in parallel or independently of each other across all layers, can increase from the outside to the inside, can decrease from the outside to the inside, or can be varied several times within a tube. For example, the number of adhesions can increase from the outside to the inside, can reach a maximum at half the diameter of the tube and can then decrease. Due to said variation, the strength and the air permeability of the tube can be adjusted for the respective application. The seamless cellulosic tube can be free from binders.

One aspect of the invention relates to a seamless cellulosic tube consisting of several layers of drawn filaments that adhere to each other section wise. Both the number and the mean diameter of the filaments can be almost constant in parallel or independently of each other across all layers, can increase from the outside to the inside, can decrease from the outside to the inside, or can be varied several times within a tube. For example, the average filament diameter of the filaments can decrease from the outside to the inside, can reach a minimum at half the diameter of the tube and can then increase. Also, in this case, the absorption capacity, the degree of separation and the air permeability of a filter can be adjusted for the respective application due to said variation.

One aspect of the invention relates to a seamless tube made of cellulosic and thermoplastic spunbonded nonwoven, having the above-mentioned variation possibilities.

One aspect of the invention relates to a seamless partially or completely carbonized or, respectively, activated tube made of cellulosic spunbonded nonwoven. With the above-mentioned variation possibilities.

One aspect of the invention relates to a filter comprising a tube.

Finally, the invention relates to the use of the filter for the adsorption, chemical binding or absorption of substances from gases, liquids and emulsions, for the separation of emulsions, for the dedusting of waste gases, as a droplet separator, for the decolorization of liquids, for the disinfection of gases and liquids, for drinking water treatment, for water softening, for separating oil from gases, for separating emulsions, for deodorization in the food industry, in the chemical industry, in the pharmaceutical industry, in the automotive industry, in the electrical industry, in the oil industry, in the petrochemical industry, in the cosmetics industry.

The invention relates to a method for the direct production of seamless, multi-layered, tubular cellulosic spunbonded nonwoven fabrics which, due to great variation possibilities with regard to the number of layers, the adhesive points, the filament diameter, the tube diameter and the length of the tube, can be perfectly adjusted for a wide variety of applications, especially for filtration applications.

### DETAILED DESCRIPTION OF THE INVENTION

For a better illustration of the invention, the essential features are depicted in the following figures, based on preferred embodiments of the device according to the invention:

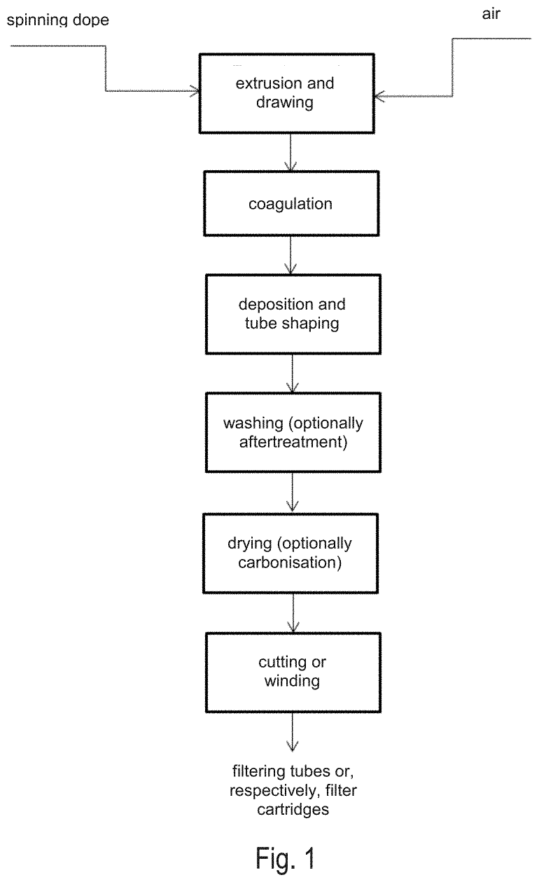

FIG. 1 shows a block diagram of the method according to the invention.

FIG. 2 schematically shows a device according to the invention for the production of filter cartridges in a side view.

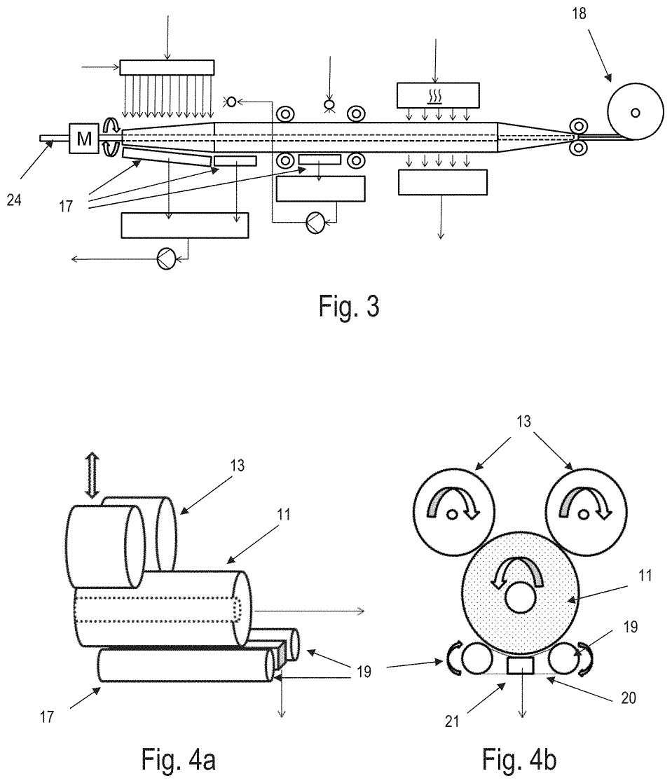

FIG. 3 schematically shows a device according to the invention for the production of filtering tubes in a side view.

FIGS. 4a, 4b schematically show the rotating deposition section in a perspective illustration and in a front view.

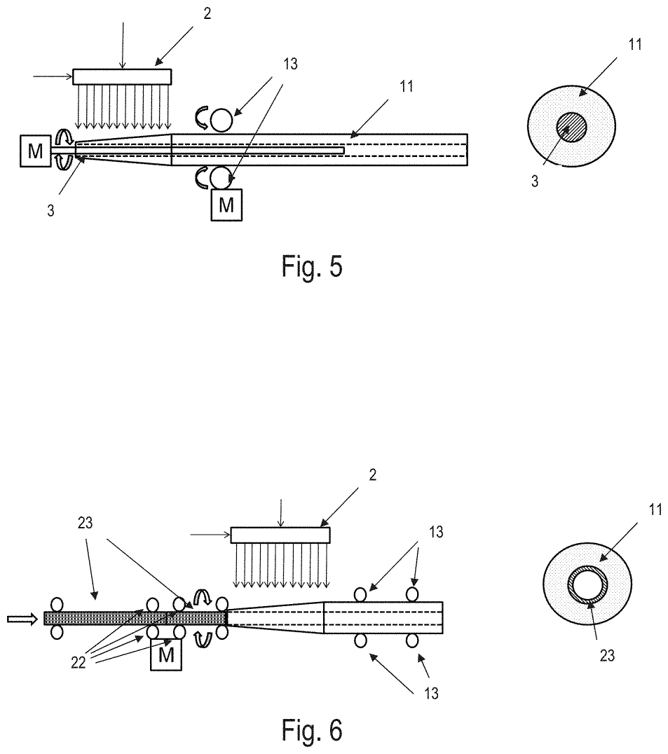

FIG. 5 shows a device according to the invention in a side view, for the continuous production of a cellulosic spunbonded nonwoven tube without a winding core.

FIG. 6 shows a device according to the invention in a side view, for the continuous production of a cellulosic spunbonded nonwoven tube with a winding core.

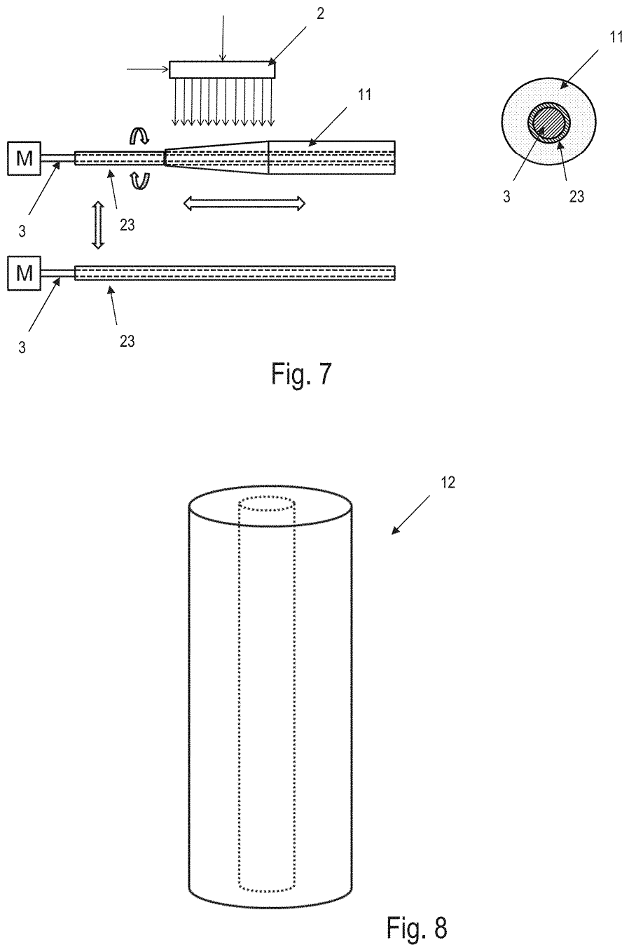

FIG. 7 shows a device according to the invention in a side view, for the batchwise production of a cellulosic spunbonded nonwoven tube with a winding core.

FIG. 8 schematically shows a piece of a spunbonded nonwoven tube and, respectively, a filter cartridge.

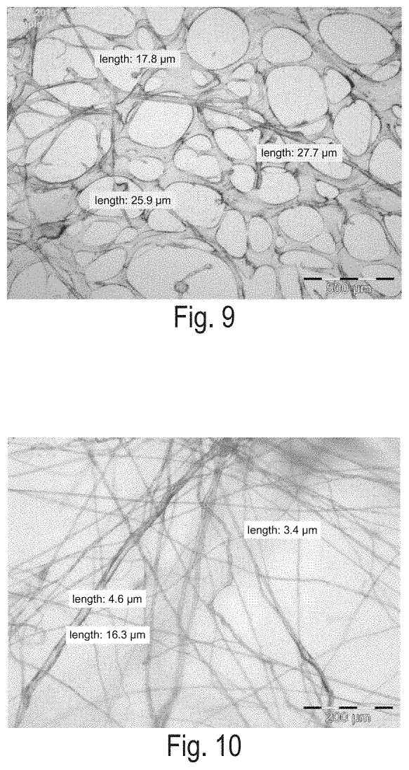

FIG. 9 shows a spunbonded nonwoven layer with many surfaces stuck together and the open pores therebetween.

FIG. 10 shows a spunbonded nonwoven layer with a small number of adhesions.

FIG. 1 shows a block diagram of the method according to the invention in which a cellulosic spinning dope is extruded through a meltblown nozzle to form fine filaments and is drawn by means of hot air. According to the invention, even before they are deposited on a rotating cylinder, the drawn filaments are moistened with coagulation liquid only to the extent that adhesions will form between the individual filaments and the individual layers of the spunbonded nonwoven tube that is produced. It has been shown that those adhesions impart sufficient stability to the spunbonded nonwoven tube after washing and drying so that, finally, it can be wound up or cut into individual tube pieces. The addition of binders was therefore not necessary, since the adhesions of individual filaments between several layers and the pronounced hydrogen bonds of the cellulose after drying impart sufficient stability and cohesion to the produced spunbonded nonwoven tube across layers so that it can be used, for example, in different areas of filtration.

For performing the method according to the invention and the production of filter cartridges, the device 1 according to the invention as described in FIG. 2 can be used. The device 1 according to the invention comprises a spinning dope production 8, a spinning system 2, and a deposition section 3 for depositing the spunbonded nonwoven, a coagulation system 4, a washing system 5 (or, respectively, aftertreatment), a drying system 6 (optionally for carbonization and activation) 6, a cutting unit 7 and a hot air supply 9. By means of the device 1 according to the invention, the filaments 10 can be extruded, drawn, coagulated and formed into a spunbonded nonwoven tube 11 on the rotating deposition section 3 for depositing the spunbonded nonwoven. Downstream of the washing system 5 and the drying system 6, the continuously produced spunbonded nonwoven tube can be wound either into filter cartridges 12 or, as shown in FIG. 3, into filtering tubes 18. The device according to FIG. 3 has essentially the same structure as the device of FIG. 2 with the difference in winding.

The continuous production of the product according to the invention without a core can be enabled by means of driven take-off rollers 13, as illustrated in FIG. 5. If the rotating deposition section 3 is a brightly polished shaft, the filtering tube is drawn from the shaft by the take-off rollers 13, and the linear movement of the rotating tube underneath the nozzle is enabled. The rotating deposition section 3 may also have at least one helical thread on the surface from front to back. Due to the friction of the spunbonded nonwoven tube shown in FIG. 3 on the external surface with the suction unit 17 and the friction with the rotating helical thread in the interior of the tube, the tube is conveyed uniformly in the direction of the washing system 5 (similar to the delivery principle of a screw conveyor or an extruder). Alternatively, however, as shown in FIG. 6, cores 23 may also be used for the deposition of the spunbonded nonwoven in order to produce filter cartridges. In this case, perforated winding cores 23 are supplied piece by piece, connected and transported further continuously via drive rollers 22. Another variant is also the batchwise production with a winding core 23, which is depicted in FIG. 7. In this case, the filaments are sprayed alternately onto two rotating deposition sections 3 for depositing the spunbonded nonwoven. While the deposition section 3 for depositing the spunbonded nonwoven is sprayed underneath the nozzle of the spinning system 2, the spunbonded nonwoven tube 11, including the core 23, is withdrawn from a second deposition section 3 for depositing the spunbonded nonwoven and is fitted with an empty core 23. The spunbonded nonwoven tube is then washed (optionally aftertreated with chemicals), dried (optionally carbonized and activated) and processed or, respectively, cut, for example, into filter cartridges 12. It has been shown that, with the present device and variations in the preferred design, seamless, multi-layered, cellulosic filtering tubes and, respectively, filter cartridges with and without a core can be produced.

FIG. 8 schematically shows a filter cartridge with the hollow space in the middle and the surrounding spunbonded nonwoven layers. Since the spunbonded nonwoven 11 is moved with the filaments 10 during spraying, the layers are gradually built up under the spinning system 2 along the movement. In this case, one spinning system 2 can be used, or several spinning systems 2 can be used, with equal or different filament diameters. It has been shown that the adhesions can be varied depending on the spinning system and, as a result, filter materials with different layers, filament diameters, pore sizes and thus a wide variety of filtration properties can be produced. FIG. 9 shows a spunbonded nonwoven layer with many adhesions, while the spunbonded nonwoven in FIG. 10 has many individual filaments. It is also possible to use additional spinning systems 2 with a non-cellulosic spinning dope, for example, thermoplastic melts, in order to produce tubular products with cellulosic and non-cellulosic layers, thereby influencing the properties of the tubular product.

The product according to the invention comprises, among other things, a seamless, multi-layered filtering tube made of cellulose, which can be processed, for example, into filter cartridges and filtering tubes. The product according to the invention may also contain non-cellulosic layers, may be chemically aftertreated or, respectively, functionalized, may contain additives for increasing the filtration performance, enhancing flame resistance, allowing ion exchange and increasing the chemical resistance against the filtration medium. In addition, the filtering tube can be carbonized and/or activated partially or completely in order to increase surface activity and adsorption properties. The product according to the invention can be used, for example, for filtration, separation, ion exchange, disinfection of liquids and gases, separation of emulsions, oil separation and other applications for filtering tubes and filter cartridges which are known to a person skilled in the art.

For the method according to the invention, a wide variety of pulps, solvents and cellulosic spinning dopes produced therefrom can be used. A spinning dope is understood to be a multi-substance system in which cellulose is solubilized by a suitable solvent, for example, ionic liquids, preferably tertiary amine oxides, more preferably an NMMO/water mixture, and, thus, becomes extrudable and spinnable. The pulp content in case of a lyocell spinning dope may be between 4 and 15%, preferably between 6% and 14%, more preferably between 7% and 13%. In case of the lyocell spinning dope, the temperature may be between 80° C. and 160° C., preferably between 90° C. and 150° C., more preferably between 100° C. and 140° C.

It has been shown that the spinning dope can be extruded and drawn by both single-row and multi-row meltblown nozzles (spinning system 2). Several sequentially arranged spinning systems 2 can be used for producing layers of different filament diameters. If only one spinning system 2 is used, the extrusion hole geometry can vary from one side of the nozzle to the other side of the nozzle both in size and in geometry (e.g., becoming larger along the nozzle, holes are circular at the beginning and Y-shaped at the end) to produce fine filaments in the inner layers and coarse filaments in the outer layers, or circular filaments inside and hollow fibres outside. Further combinations of size, gradient and geometry are possible depending on the desired product properties. In this case, the hot process air emerges from a gap or from a hole next to or around the extrusion openings and entrains the spinning dope filaments, depending on the nozzle design. The filament is accelerated, and the diameter is reduced. Subsequently, the filaments are swirled by the turbulence of the process air and can be deposited as a spunbonded nonwoven on a rotating surface. The nozzle length may be between 50 mm and 2000 mm, preferably between 100 mm and 1000 mm, more preferably between 200 mm and 500 mm. The cellulose throughput may be between 1 kg/h/m and 500 kg/h/m nozzle length, preferably between 15 kg/h/m and 250 kg/h/m, more preferably between 20 kg/h/m and 100 kg/h/m. The extrusion holes of the nozzle may be between 0.05 mm and 3 mm, preferably between 0.2 mm and 1 mm, more preferably between 0.3 mm and 0.6 mm. The pulp throughput per extrusion hole may be between 0.001 g/hole/min and 30 g/hole/min, preferably between 0.1 g/hole/min and 20 g/hole/min, more preferably between 1 g/hole/min and 10 g/hole/min. In case of single-row slot nozzles, the air gap width may be between 0.5 mm and 5 mm, preferably between 1 mm and 3 mm, more preferably between 1.5 mm and 2 mm. In case of multi-row nozzles, the air outlet diameter may be between 0.5 mm and 5 mm, preferably between 1 mm and 3 mm, more preferably between 1.5 mm and 2 mm. The process air overpressures that are used may be between 0.1 bar and 10 bar, preferably between 0.3 bar and 5 bar, more preferably between 0.5 bar and 2 bar. This results in air outlet speeds at a nozzle distance of 20 mm of 50 m/s to 300 m/s, preferably 70 m/s to 250 m/s, more preferably 100 m/s to 200 m/s. At a distance between the nozzle and the rotating tray of 50 mm to 1000 mm, preferably 200 mm to 800 mm, more preferably 300 mm to 600 mm, there will be diameters of individual fibres of 0.1 μm to 100 μm, preferably 0.5 μm to 50 μm, more preferably between 1 μm and 30 μm.

It has been shown that the degree of adhesion can be specifically influenced by the coagulation, i.e., the regeneration of the cellulose. In this connection, the fusion of several individual filaments at their points of contact is referred to as an adhesion. Before they impinge on the tray, the filaments are moistened with the coagulation liquid only to the extent that they remain partly liquid and fuse together upon contact, whereby an adhesion is created. According to the invention, no coagulation liquid is applied in extreme cases, and a maximum of adhesions is thereby produced. In this case, the adhesions can be spherical, for example, or else flat and can have a diameter of 10 μm to 500 μm, preferably 30 μm to 300 μm, more preferably 50 to 200 μm. The coagulation liquid can either be injected directly into the process air or sprayed onto the filament curtain via a wide variety of spraying and nebulization systems. Water and various solvent mixtures such as, e.g., an NMMO/water mixture can be used as the coagulation liquid. The concentration of NMMO in the coagulation liquid may be between 0-45%, preferably from 10 to 40%, more preferably between 20 and 30%. The temperature of the coagulation liquid may be between 5° C. and 90° C., preferably between 10° C. and 70° C., more preferably between 20° C. and 60° C.

After coagulation, the filaments are deposited on a rotating deposition section 3 for depositing the spunbonded nonwoven. The rotating deposition section 3 for depositing the spunbonded nonwoven may be like a driven shaft or, respectively, a mandrel made of metal. The diameter of the rotating tray may be between 1 cm and 100 cm, preferably between 1.5 cm and 50 cm, more preferably between 2 cm and 30 cm. Depending on the nozzle length, the rotating tray may have a length of 25 to 500 cm, preferably 50 to 400 cm, more preferably 100 to 300 cm, for a continuous production without a core (FIG. 5). In a continuous core production involving a core as shown in FIG. 6, the winding cores are used as a rotating tray. In both cases, drive rollers 22 and take-off rollers 13 can be used for the continuous production to permit the linear movement of the spunbonded nonwoven tube along the nozzle length. In the batch production as shown in FIG. 7, the entire rotating tray is moved under the spinning system in order to load the core with layers of spunbonded nonwoven. When a core is coated, it is pulled away from the nozzle and replaced with a new core. The latter is then again shifted linearly along the nozzle until a spunbonded nonwoven tube is formed. In all three cases, the linear movement of the rotating tray 3 under the spinning system 2 is responsible for the fact that the spunbonded nonwoven tube is built up from the inside to the outside. Therefore, a variation in the filament fineness along the spinneret has the effect that the porosity and, respectively, the air permeability of the different layers can be varied. This type of product variation is especially desirable for filtration applications. The filtering tube consists of at least one layer. It has been shown that the number of layers and thus the thickness of the produced filtering tube can be varied depending on the application by adjusting either the throughput through the nozzle, the rotational speed of the rotating tray 3 or the take-off speed of the drive and take-off rollers, respectively.

According to the invention, the deposition can also be influenced by using a perforated pipe placed under vacuum 24 as the rotating tray. In doing so, the filaments are specifically aspirated and simultaneously dewatered. Excess coagulation liquid either can, as shown in FIG. 2, be drained off and collected with drain trays, or can be removed actively via the suction unit shown in FIG. 4a. The rotatable deposition section 13 shown in FIG. 4a has a suction unit which can be used for removing the coagulation liquid, the process air and the washing liquid in the washing. In this case, the spunbonded nonwoven tube is supported by pulleys 19 and/or, as illustrated in FIG. 4a, by a conveyor belt 20. The pulleys 19 and, respectively, the conveyor belt 20 thereby rotate at the same speed as the rotating tray 3 or, respectively, the spunbonded nonwoven tube 11. Between the pulleys 19 and under the conveyor belt 20, there is a suction unit 21. The spunbonded nonwoven tube is dewatered by means of the suction unit. As shown in FIG. 4b, the dewatering effect can be enhanced by the take-off rollers 13, which, in this case, serve as pressure rollers. The moisture content can be reduced down to 30% by the dewatering unit. As illustrated in FIG. 3, the liquids from the dewatering boxes reach either the coagulation container 15 or the washing-system container 14. The liquid from the coagulation container 15 is supplied to the solvent recovery, while the liquid from the washing-system container can be used for the coagulation system 4.

After the formation of the nonwoven, the spunbonded nonwoven tube gets into the washing. The remaining solvent is thereby removed from the spunbonded nonwoven tube. The spunbonded nonwoven tube either can be guided through a basin or bath, under spray nozzles or other sprinklings in which water is supplied in counterflow and solvent is discharged, or through several consecutive stages in which, for example, water is sprayed onto the spunbonded nonwoven tube in counterflow and either drips off or is removed by the suction unit 17. The washing can consist of several washing stages in which the counterflow extraction is repeated until the desired purity is obtained. The temperature of the washing liquid may be between 20 and 90° C., preferably between 30 and 85° C., more preferably between 40 and 80° C. The temperature can also be varied for the different washing stages. For example, the first washing stage may be warmer than the last one. Based on the counterflow principle of the washing, the concentration of the solvent in the spunbonded nonwoven tube decreases, while the wash water is concentrated. The concentrated wash water can then be used for the coagulation. In the washing, the properties of the spunbonded nonwoven tube can be influenced by the addition of chemicals, for example, in order to increase the temperature resistance, chemical resistance, dimensional stability and filtration performance by functional groups. Furthermore, disinfectants and flame retardant impregnating agents may also be added (chemical aftertreatment).

After washing, the spunbonded nonwoven tube 11 still has to be dried. In doing so, flow dryers (convection dryers), radiation dryers (IR, UV, microwave) as well as contact dryers with heated rollers can be used. In this case, the moisture content is reduced to 2 to 14%, preferably 4 to 12%, more preferably 6 to 10%. It has been shown that the spunbonded nonwoven tubes can also be carbonized and/or activated partially or completely upon appropriate impregnation in the washing. As a result, the specific surface area of the product, the absorption and adsorption properties are significantly increased.

In a continuous production, the spunbonded nonwoven tube can either be cut into smaller units (FIG. 2) or wound up as a tubular roll (FIG. 3).

The washing (chemical aftertreatment) and drying (or, respectively, carbonization) as described is performed batchwise in a batch production.

The manufactured product can be used as a pure cellulose spunbonded nonwoven tube, as a cellulose/thermoplastic spunbonded nonwoven tube, as a carbonized spunbonded nonwoven tube, as an activated spunbonded nonwoven tube, chemically aftertreated in order to increase flame resistance and temperature stability and to improve the adsorption, the chemical binding and the absorption of substances from gases, liquids and emulsions, for example, as a filter cloth, filter cartridge, filtering tube, bag filter, for separating solids from gases and liquids, for separating liquids from gases, for separating emulsions, for the dedusting of waste gases, as a droplet separator, for the decolorization of liquids, for the disinfection of gases and liquids, for drinking water treatment, water softening, the separation of oil from gases, the separation of emulsions, for deodorization in the food industry, in the chemical industry, in the pharmaceutical industry, in the automotive industry, in the electrical industry, in the oil industry, in the petrochemical industry, in the cosmetics industry and in the private sector.

Furthermore, the product according to the invention can be used for extraction sleeves in the laboratory and as a filter for instrumental analysis. The filtering tube can also be processed, for example, into tea bags and coffee filters.

In the cosmetics sector, the filtering tube can be used, for example, as a finger tube for applying and, respectively, removing cosmetics (cream, powder, . . . ). Cellulosic filtering tubes can be used commercially as a biodegradable packaging material for fruits and vegetables. Due to the water absorption of the cellulose, the product according to the invention is also suitable for packaging and as a corrosion protection of metal parts for transport and storage. In the agricultural sector, the product of the invention can be used for protecting plants from mechanical attack, desiccation, insects and animals or for supplying nutrients to the plant.

The spunbonded nonwoven tube can also be used as a bandage in the therapeutic or medical field for supporting the musculature, as a wound dressing, as a support bandage, for moisture regulation and for the promotion of wound healing.

1. A device for producing a seamless tubular cellulosic spunbonded nonwoven fabric, comprising:
a spinning dope production,
a spinning system,
a coagulation system,
a deposition section for depositing and dewatering the spunbonded nonwoven,
a transport device for carrying off the spunbonded nonwoven in a transport direction,
a washing system and
a drying system,
wherein the deposition section is designed so as to be rotatable, with an axis of rotation of the deposition section lying along the transport direction.

2. The device according to claim 1, further comprising at least one suction device associated with the deposition section.

3. The device according to claim 2, wherein the at least one suction device is inclined at least in sections.

4. The device according to claim 1, further comprising a cutting unit.

5. A method of producing a seamless multi-layered tubular cellulosic spunbonded nonwoven fabric, comprising:
processing cellulose into a spinning dope and, subsequently, extruding the spinning dope with a spinning system to form drawn filaments by using hot air, and
moistening the drawn filaments, before a deposition, with a coagulation liquid in such a way that adhesions will form at least between the drawn filaments or across several layers during the deposition, wherein the drawn filaments are deposited on a rotating tray, dewatered, washed and dried.

6. The method according to claim 5, further comprising washing a solvent out of the spunbonded nonwoven and supplying it to a solvent recovery.

7. The method according to claim 6, further comprising extracting process air and supplying it to the solvent recovery.

8. A seamless tube comprising several layers of drawn cellulose filaments, wherein the cellulose filaments adhere to each other in each layer section wise, and wherein the individual layers adhere to each other section wise, with the tube being essentially free from binders.

9. A filter comprising a tube according to claim 8.

10. The filter according to claim 9, wherein the filter is used for at least one of: adsorption, chemical bonding or absorption of substances from gases, liquids and emulsions, separation of emulsions, dedusting of waste gases, as a droplet separator, decolorization of liquids, disinfection of gases and liquids, drinking water treatment, water softening, separating oil from gases, separating emulsions, deodorization in the food industry.

11. A method according to claim 5, wherein the drawn filaments adhere to each other section wise.
